(19) United States
(12) Patent Application Publication
(10) Pub. No.: US 2010/0050872 A1
(43) Pub. Date: Mar. 4, 2010

(54) FILTER AND METHODS OF MAKING AND USING THE SAME

(76) Inventor: Kwangyeol LEE, Namyangju-si (KR)

Correspondence Address: EDWARDS ANGELL PALMER & DODGE LLP, P.O. BOX 55874, BOSTON, MA, 02205, US

(21) Appl. No.: 12/202,061

(22) Filed: Aug. 29, 2008

(51) Int. Cl. B01D 39/14; B01D 50/00; B01D 39/16; B29C 47/00; B01D 39/00

(52) U.S. Cl. 95/279; 55/527; 55/524; 210/504; 264/465; 977/777; 977/891

(57) ABSTRACT

The filter provided herein includes one or more nanofibers. In some examples of the filter, the nanofibers include one or more nanoparticles, in which the nanoparticles are at least partially surrounded by pockets.

### BACKGROUND

A nanofiber is generally a fiber with a diameter ranging from about 1 nanometer (nm) to about 1,000 nm. This fine diameter allows a nanofiber to be lightweight and have a large surface area. After the initial introduction in 1934 by a technology called electrospinning, nanofibers have been studied for use in medical and other industrial applications. Examples of various applications include drug delivery systems, battery separators, energy storage, fuel cells, and information technology.

### SUMMARY

Some embodiments relate to filters that include, for example, one or more nanofibers, one or more nanoparticles, wherein the nanoparticles are at least partially embedded in the nanofibers, and one or more pockets, wherein the pockets are at least partially surrounding the nanoparticles.

Other embodiments relate to devices such as, for example, an air-conditioner, an air-purifier, an air-cleaner, a water-filtering system, and a water-purification system, which include a filter that contains the nanofibers, nanoparticles and pockets described above and elsewhere herein.

In some other embodiments, methods of manufacturing the filter having the nanofibers, nanoparticles and pockets are provided. Such methods in general can include heating one or more nanoparticles coated with a surfactant in an organic solvent, mixing a molten nanofiber source material together with the nanoparticles in the organic solvent, evaporating the organic solvent from the mixture of molten nanofiber source material and the heated nanoparticles, making a nanoparticle-embedded nanofiber from the mixture of molten nanofiber source material and heated nanoparticles, removing the surfactant from the nanofiber, and forming the filter from the one or more nanofibers.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE FIGURE

The foregoing and other features of the present disclosure will become more fully apparent from the following description and appended claims, taken in conjunction with the accompanying drawing. Understanding that the drawing depicts only several embodiments in accordance with the disclosure and is, therefore, not to be considered limiting of its scope, the disclosure will be described with additional specificity and detail through use of the accompanying drawing.

FIGS. 1A and 1B are depictions of an illustrative embodiment of a nanofiber-containing filter.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some aspects of the present disclosure relate, inter alia, to filters that includes one or more nanofibers and to methods of making and using the filters. In some embodiments, the nanofibers can include one or more nanoparticles that are at least partially surrounded by pockets. The methods of using the filters can include, for example, methods of filtering a material that is desired to be filtered.

In order to filter a material to be filtered, a filter that includes one or more nanofibers is provided. In some embodiments, the nanofibers can include one or more nanoparticles that are at least partially surrounded by pockets.

As discussed above, a nanofiber is generally a fiber with a diameter ranging from about 1 nanometer (nm) to about 1,000 nm. The average diameter of nanofibers used in connection with particular embodiments herein is in the range of from about 1 nm, 10 nm, 50 nm, 100 nm, or 500 nm to about 10 nm, 50 nm, 100 nm, 500 nm, or 1,000 nm. In some embodiments, the average diameter of nanofibers is between about 10 nm to about 100 nm.

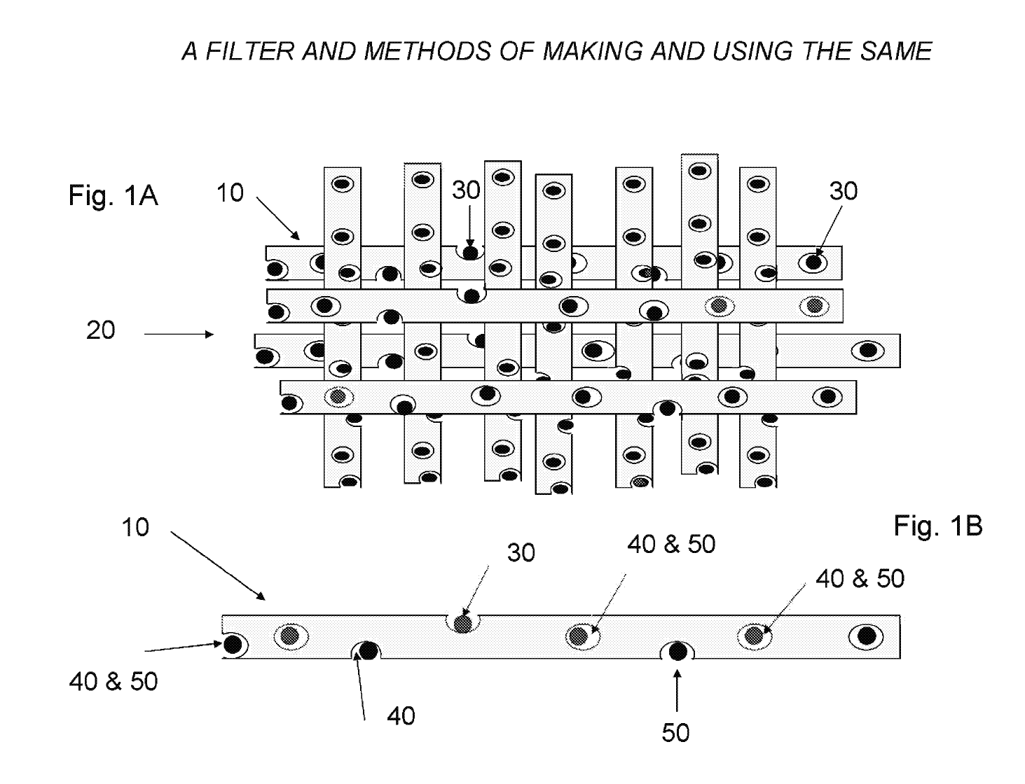

Referring to FIG. 1, in general, nanofibers 10 used in various embodiments can include any source material that can be made into a nanofiber. Thus, for example, nanofibers 10 can include any of a number of different elements that are capable of forming nanofibers. These include, but are not limited to, silica, carbon, and a combination thereof. In some embodiments, nanofibers 10 can include, for example, silica.

In some embodiments, nanofibers 10 include one or more nanoparticles 30. In general, nanoparticles 30 can be dispersed on and/or embedded in one or more nanofibers 10.

Nanoparticles 30 can be shaped into a variety of morphologies, including any regular or irregular shaped two-dimensional structures, and any regular or irregular shaped three-dimensional structures. Thus, in some illustrative embodiments, nanoparticles 30 can be in the shape of a cylinder, a sphere, a rod, a tubular structure, and any type of hexahedron. In general, the average size along any dimension (e.g. diameter, width, length, or height) of the nanoparticle is more than 0 nm and equal to or less than about 1,000 nm. In some embodiments, the average size along any dimension (e.g. diameter, width, length, or height) of the nanoparticle 30 can be in the range from about 1 nm, 3 nm, 10 nm, 50 nm, 100 nm, 500 nm, or 800 nm to about 3 nm, 10 nm, 50 nm, 100 nm, 500 nm, 800 nm, or 1,000 nm, or any value there between. In particular embodiments, the average size along any dimension (e.g. diameter, width, length, or height) of the nanoparticle 30 can be in the range from about 3 nm to about 50 nm.

In some embodiments, the nanoparticles 30 can include, but are not limited to, silver (Ag), copper (Cu), iron (Fe), platinum (Pt), nickel (Ni), titanium (Ti) and combinations thereof. An illustrative nanoparticle contains silver (Ag). While not intending to be limited by the following, nanoparticles such as silver nanoparticles can at least partially remove and/or destroy some microorganisms present in the material to be filtered such as air and water via at least two mechanisms. These mechanisms include denaturation of biological molecules (e.g. proteins and non-proteins) and production of reactive oxygen species such as hydrogen peroxide. It is feasible that denaturation of biological molecules and production of reactive oxygen species can occur simultaneously or separately.

Nanoparticles such as silver nanoparticles can denature at least some biological molecules of at least some microorganisms including bacteria, viruses, fungi and others. For example, proteins present in bacteria, viruses, fungi and other microorganisms that have disulfide bonds, for example within one protein or between two or more proteins and/or non-proteins, can be denatured by nanoparticles such as silver nanoparticles. While not intending to be limited by the following, it is believed that when such microorganisms come into contact with silver nanoparticles, the silver nanoparticles act as catalysts in inducing an oxidation of the disulfide bonds via reaction with oxygen present in the material to be filtered. An illustrative example of the material to be filtered that contains oxygen can include, but is not limited to, air and water. As a result, disulfide bonds are cleaved and this cleavage of disulfide bonds within biological molecules (e.g. proteins and non-proteins) can cause those biological molecules to denature. Such denaturation of biological molecules often leads to the loss of function of the biological molecules which can in turn cause physiological defects in growth and/or metabolism of microorganisms.

Nanoparticles such as silver nanoparticles can also produce reactive oxygen species, such as hydrogen peroxide, by acting as a catalyst. For example, silver nanoparticles can catalyze oxidation reactions of oxygen, hydrogen and/or water to form hydrogen peroxide. In some illustrative examples, generation of hydrogen peroxide can denature biological molecules of bacteria, viruses, fungi and other microorganisms resulting in removal or destruction of such microorganisms from materials to be filtered.

In another illustrative embodiment, the nanoparticle can be a platinum (Pt) nanoparticle. Platinum can be used for example to filter hazardous gas or gasses from materials to be filtered. Such materials to be filtered can include, but are not limited to, air and water, for example. In some embodiments, platinum can be used to remove gasses including nitrogen gases such as nitrogen oxides, which can include for example, nitrous oxide, nitric oxide, nitro oxide, and the like. Platinum can adsorb nitrogen oxides with higher affinity than oxygen and some other gases. Therefore, as one example, nitrogen oxides which are often generated from vehicle engines can be filtered out through the filter with platinum nanoparticles that are presented in some embodiments herein.

Referring to FIG. 1, in various embodiments, the nanoparticles 30 are at least partially surrounded by pockets 40. The pocket 40 is a space or void present in the nanofiber 10 that optionally has an external opening 50. The space of the pockets can contain or be filled with air, for example. In some embodiments the pockets can contain or can be filled with any other type of gas, fluid and/or compound. For example, the liquid can include water or water-containing liquids (e.g., waste water), solvents including organic or inorganic solvents, fuels including gas and diesel fuels, or any combination thereof, for example, depending on the material with which the fiber comes into contact.

As illustrated in FIG. 1B, the nanofibers can include an external opening 50, which can contain a nanoparticle 30. The nanoparticle 30 can be at least partially surrounded by a pocket 40, and can contact external materials through opening 50. In some embodiments, such external materials can include, for example, the materials to be filtered.

In some illustrative examples, the pocket can enhance the ability of the filter with nanoparticles to filter materials to be filtered. For instance, microorganisms such as bacteria, viruses, fungi and others, and/or some air pollutants, including soot particulates may need to be removed from, or reduced in, materials to be filtered, for example, air and/or water. In such examples, when the targeted microorganisms and/or air pollutants contact the pockets, at least some of those targeted microorganisms and/or air pollutants can enter the pocket and be captured inside the pocket. Such capturing may remove or reduce at least some targeted microorganisms and/or air pollutants from air and/or water. In addition, at least some chemical substances in certain solvents can be filtered and removed from the solvents. For example, the solvents having the substances that need to be removed via filtering can include, but are not limited to, organic or inorganic solvents, fuels such as gas and diesel fuels, or any combination thereof. Furthermore, microorganisms in pockets can come into contact with nanoparticles, such as for example, silver nanoparticles. Microorganisms can contact nanoparticles such as silver nanoparticles without being captured in a pocket and can be removed and/or destroyed via the antiseptic activity of the nanoparticles, such as silver nanoparticles. Nanoparticles such as silver nanoparticles can remove or destroy microorganisms via at least two mechanisms that are described elsewhere herein. Such removal and/or destruction of targeted microorganisms can be enhanced by the presence of pockets. The ability to capture microorganisms within pockets can result in an increase in the time and the probability that a microorganism can come into contact with a nanoparticle, such as a silver nanoparticle. Consequently, the efficiency of removal and/or destruction of targeted microorganisms by nanoparticles such as silver nanoparticles can be improved when pockets are present in the filter.

A filter 20 made up of one or more nanofibers 10 can be manufactured in a variety of sizes and shapes, for example, in some cases at least in part based upon the proposed use. The size and/or shape can be in accordance with shapes and size known in the art in view of the disclosure herein. Moreover the filter 20 can have a single-layered or a multiple-layered structure, for example.

The material to be filtered in various embodiments can generally include, but is not limited to, any gas, liquid, gel, or any combination thereof. Air, oxygen, carbon dioxide, nitrogen, hydrogen, any other gas to be filtered or any combination thereof are non-limiting examples of gases that can be filtered. Liquids can include, but are not limited to, water, saline solution, medical solution, biological solution, pharmaceutical solution, oil, waste water, solvents including organic or inorganic solvents, fuels such as gas, diesel fuels, or any combination thereof. In some illustrative examples, air in a medical and/or laboratory space can be filtered with the filter having nanoparticles and pockets. For example, if sterile air conditions are required in a certain laboratory space (e.g., a biosafety level 3 or 4 facility), the filter that includes nanoparticles and pockets can be installed in order to filter any air flow from the outside to the inside of the laboratory space and/or vice versa. Such a filter can remove and/or destroy at least some microorganisms including bacteria, viruses, fungi and others present outside the laboratory and help to keep air inside the laboratory substantially clean. In another embodiment, synthetic and/or natural chemicals can be filtered through the filter. In another illustrative example, the filter with nanoparticles and pockets can be used in a water tank such as an aquarium. For example, the filter can be installed inside an aquarium. The filter can be used to remove and/or destroy at least some microorganisms including bacteria, viruses, fungi, and others, as well as one or more hazardous gasses including nitrogen oxide(s) which can be produced from animals in the tank. In some other embodiments, the filter can be used to filter unwanted chemicals or particles from fuel such as gas or diesel fuel. Alternatively, the filter can be used to filter organic or inorganic solvents. For example, an alcohol such as methyl or ethyl alcohol can be filtered to remove at least some contaminants (e.g., microorganisms or chemicals) that may be present in the methyl or ethyl alcohol solution. Also, for example, if an alcohol solution is contaminated with nitrogen gas, at least some of the nitrogen gas can be removed using a filter as described herein, for example, a filter that includes platinum nanoparticles.

In various embodiments, the filter with nanoparticles and pockets can be used at least in part to filter contaminating and/or hazardous substances present in the material provided for filtration. Such filtering process can be accomplished utilizing at least three portions of the filter: the (1) nanofibers, (2) nanoparticles, and (3) pockets, for example. These three portions can function alone or in any combination during filtering. When two or more of such filtering functions occur, these two or more functions can occur sequentially or simultaneously.

Examples of contaminants and/or hazardous substances that can be filtered include, but are not limited to, both biological substances and chemical substances. Examples of biological substances include, but are not limited to, potentially harmful organisms present in the material that is desired to be filtered. For the purposes of reference herein to the biological substance-filtering of a microorganism can includes filtration of bacteria, viruses, fungi, mycoplasma, parasites, and mites, and the like. Chemical substances that can be filtered generally include, but are not limited to, synthetic or natural inorganic chemicals, synthetic or natural organic chemicals, metals, sand particles, clay particles, various gasses including nitrogen oxides, and other non-living substances. For example, the filtration of nitrogen oxides using platinum containing nanoparticles/nanofibers is described more fully elsewhere herein. In particular, organic chemicals can include, for example, chemicals originating from living organisms such as microorganisms, plants, and animals including humans.

In some aspects the nanofibers can be used to filter target substances. The nanofibers can include, for example, carbon, such as, for example, elemental carbon or activated carbon. Carbon can adsorb with high affinity at least some synthetic or natural aromatic compounds that are often found in odorous substances, relative to absorption of non-aromatic compounds by carbon. Therefore, nanofibers including carbon can be used in part to remove synthetically or naturally originating aromatic or odorous molecules.

In some aspects, the nanoparticles can include silver, for example. As described elsewhere herein, silver can act as a catalyst to induce oxidation reactions. Such oxidation can cause, for example, denaturation of biological molecules (e.g. proteins and non-proteins) of microorganisms and production of reactive oxide species such as hydrogen peroxide. Reactive oxide species such as hydrogen peroxide can also denature biological molecules of microorganisms. Therefore, silver nanoparticles can denature biological molecules of microorganisms which can cause malfunction and/or loss of function of some biological molecules. Such damage on biological molecules can lead to substantial defects in growth and/or metabolisms of microorganisms, leading to removal and/or destruction of microorganisms.

In another illustrative example, one or more gasses can be removed from materials to be filtered such while other gasses are not removed. For example, the gasses can be at least partially removed from substances such as (but not limited to) air, water, solvents including organic or inorganic solvents, fuels such as gasoline or diesel fuels. In such instances, the nanoparticles can include platinum. Platinum can adsorb nitrogen oxides with higher affinity than platinum adsorbs oxygen, for example. Therefore, nitrogen oxide(s) that can be generated from gasoline engines, diesel engines, cooking ovens, combustion sources, and others can be removed or reduced when the filter contains platinum nanoparticles. In some examples, the filter with platinum nanoparticles can be installed in cars or cooking ovens to remove or reduce nitrogen oxide(s) as well as other particulates such as soot.

As mentioned elsewhere herein, the pockets can assist in filtering targeted substances, such as for example, microorganisms (such as viruses) and/or some chemicals (such as soot particles). In general, the size of a virus to be filtered can be between about 10 nm to about 2,000 nm. Due to such small sizes, viruses can be present in air, for example, without being visible. In one example, the filter can contain nanoparticles and pockets, and this filter can be used to remove and/or destroy viruses from materials such as air. When a virus contacts a pocket, some of the virus can enter the pocket and can remain inside the pocket (e.g. for several seconds to several days). Capturing viruses within pockets may remove at least some of the viruses from the material subject to filtration, such as air. Furthermore, biological molecules of captured viruses can be denatured once the viruses contact the nanoparticles such as silver nanoparticles that can be present, e.g., in the pocket. Therefore, the pockets, alone or in combination with the nanoparticles can remove and/or destroy microorganisms. In the case of synthetic chemicals such as soot particles, the pockets also can capture such soot particles and consequently exclude such particles from the air.

Methods of preparing the filter include, but are not limited to, heating one or more nanoparticles coated with a surfactant in an organic solvent. Such heating of the nanoparticles in the organic solvent can be performed at temperatures ranging from about 50° C. to about 200° C., for example. In some illustrative embodiments, the heating process of nanoparticles in the organic solvent can be performed at temperatures ranging from about 50° C., 80° C., 100° C., 120° C., 150° C., or 180° C. to about 80° C., 100° C., 120° C., 150° C., 180° C., or 200° C. The nanoparticles can be coated with a surfactant using techniques, including but not limited to, dip-coating methods and spin-coating methods that are well known to those skilled in the art. A wide variety of known surfactants can be used. Some examples of surfactants can include, but are not limited to, one or more of dodecane thiol, trioctylphosphine, oleic acid, cetyltrimethyl ammoniumbromide (CTAB), hexadecyltrimethyl ammoniumbormide (HTMAB2), P123, Triton X-100, other known surfactants, and combinations thereof. A wide variety of known organic solvents can also be used. Thus, in some embodiments, the organic solvent can include, but is not limited to, toluene, acetone, benzene, cyclohexane, t-butyl alcohol, other known organic solvents, and combinations thereof. In some embodiments, the heating optionally involves boiling the organic solvent.

In some embodiments, the method of preparing the filter can include, but is not limited to, heating a nanofiber source material to generate molten nanofiber source material. Heating the nanofiber source material in general can be performed at temperatures ranging from about 100° C. to about 400° C. In some embodiments, the temperature for generating molten nanofiber source material can be between about 100° C., 150° C., 200° C., 250° C., 300° C., or 350° C. to about 150° C., 200° C., 250° C., 300° C., 350° C., or 400° C. In some examples, silica is used as the nanofiber source material. In such instances, any material that can provide silica such as, but not limited to, polycarbonsilane, can be used.

In some embodiments, the methods of preparing the filter can include, but are not limited to, mixing the molten nanofiber source material with the heated nanoparticles in the organic solvent. In some illustrative embodiments, the weight of nanoparticles that is mixed with molten nanofiber source material can be, for example, about 0.1% to about 10% of the weight of the molten nanofiber source material. Generally, the weight of nanoparticles that is mixed with the molten nanofiber source material can be, for example, about 0.1%, 0.5%, 1%, 2%, 3%, 4%, 5%, 6%, 7%, 8%, or 9% to about 0.5%, 1%, 2%, 3%, 4%, 5%, 6%, 7%, 8%, 9% or 10% of the weight of the molten nanofiber source material.

In some embodiments, the methods of preparing the filter can include, but are not limited to, evaporating the organic solvent from the mixture of molten nanofiber source material and heated nanoparticles. In certain embodiments, the mixture of molten nanofiber source material and boiled, surfactant-coated nanoparticles can be heated to a temperature above the boiling point of the organic solvent. In illustrative embodiments, when toluene is used as solvent, heating the mixture at about 250° C. to about 350° C. for about 1 hour to about 24 hours can be used to evaporate the organic solvent.

In some embodiments, the methods of preparing the filter can include, but are not limited to, preparing the nanoparticle-embedded nanofiber from the mixture of molten nanofiber source material and heated nanoparticles using one or more techniques such as, but not limited to, an interfacial polymerization method, a gel-sol method, an electrospinning method, and other methods for preparing nanofibers. The resulting nanofiber can include one or more nanoparticles, wherein the nanoparticles are at least partially embedded in the nanofiber.

In some embodiments, the methods of preparing the filter can include, but are not limited to, removing the surfactant from the nanofiber. In certain embodiments, removal of the surfactant from the nanofiber can be accomplished by heating to a temperature, for example, in the range of from about 200° C. to about 700° C. In some embodiments, heating can be performed at a temperature in the range of from about 200° C., 250° C., 300° C., 350° C., 400° C., 450° C., 500° C., 550° C., 600° C., or 650° C. to about 250° C., 300° C., 350° C., 400° C., 450° C., 500° C., 550° C., 600° C., 650° C., or 700° C. In some embodiments, the heating can be to a temperature in the range of from about 350° C. to about 550° C. The heating process can cause decomposition of the surfactant covering the nanoparticles. As the surfactant is decomposed, it is converted to gaseous material that evaporates from the nanofiber. Such removal of the surfactant including decomposition and evaporation can result in the formation of an opening on the surface of the nanofiber. After the surfactant is removed, the opening and the space which was previously filled with the surfactant remains empty and is referred to herein as the pocket.

One or more nanofibers containing nanoparticles and pockets can then be further formed to be any size and shape of a filter using any suitable technique. One illustrative method of forming filter with nanofibers is to produce nanofibers that contain nanoparticles and pockets, and to form the filter with the nanofiber continuously. In some embodiments, fibers with nanoparticles and pockets can be made via an electrospinning method. Such produced fibers can be assembled by direct fiber-to-fiber formation to create nonwoven assembly. Once the nonwoven fibers with nanoparticles and pockets are formed, the nonwoven fiber can then be further woven, knitted, or braided. Fiber assemblies can be operated mechanically or by electrostatic field control. Alternatively, self-assembled filters can be produced with appropriate control of electrospinning parameters and conditions, as is known in the art. The fibers are allowed to accumulate until a tree-like structure is formed during electrospinning. Once a sufficient length of fibers is formed, the accumulated fibers attach themselves to the branches and continue to build up.

According to some embodiments, the filter can be regenerated. Regenerating the filter in general can include removing and/or reducing the filtrand present following filtration of one or more substances and/or materials. In some embodiments, the filtrand can be removed sufficiently so that the filter can be reused following cleaning.

In one embodiment, the filter can be regenerated by heating, since the physical and chemical features and structures of the filter in general are unperturbed at high temperatures. For example, the filter can be heated to a temperature within the range from about 200° C. to about 2,000° C. In some embodiments, the heating can be to temperatures in the range from about 250° C. or about 300° C. to about 500° C. or about 1000° C., for example. In one illustrative embodiment, the heating temperature can be about 400° C. The length of heating can vary depending on the temperature and the filtrand. Illustrative heating periods can be from about 5 minutes to about one week. Thus, in some embodiments, the heating period is from about 10 minutes or 20 minutes to about one hour or one day. In one illustrative embodiment, the heating period is about 30 minutes. In some embodiments, regeneration can occur at prevailing atmospheric pressure (about 1 atm.). However, in other embodiments, cleaning can be performed under pressure or in a vacuum. Thus, in some embodiments, the pressure can range from 0.001 atm. to about 10 atm. In some embodiments, cleaning can be performed in a reducing environment, such as in the presence of hydrogen (H₂) gas, or in an oxidizing atmosphere containing various percentages of oxygen (O₂) gas. Such heating can destroy most, if not all, filtrand substances present in the filter.

Another illustrative method of regenerating the filter can include, for example, exposing the filter to radiation or other energy such as ultrasound. In such methods, the filter can be exposed to radiation such as visible light, infrared light, ultraviolet light, microwave, X-ray and the like. For example, ultraviolet light is well known for its ability to kill microorganisms. Therefore, in some embodiments, bacteria, viruses, fungi and other filtered organisms are removed, reduced or destroyed by exposing the filter to UV for a time period in the range of from about 5 minutes to about 24 hours, depending on the amount of filtrand on the filter and the strength of the UV radiation. In one illustrative embodiment, the exposure is for one hour.

Some embodiments relate to devices that include a filter as described herein. In general such devices can include, but are not limited to, air-conditioners, air-purifiers, air-cleaners, water-filtering systems, water-purification systems, and any other device designed for filtering purposes. A device that includes the filter can be installed permanently or temporarily in an area in which use of the filtering system is desired, for example. In addition, a device that includes the filter can be designed to be transportable. For instance, the device that includes the filter can be used as a portable water or air filtering system for use in a variety of activities such as sports.

Some embodiments relate to the application of the filters for filtering in a variety of locations. Examples of locations in which filtering might be desired include, but are not limited to, a residential area, a commercial area, a non-commercial area, a school, a hospital, a research or manufacturing facility, a vehicle such as a car, airplane, train, subway, or watercraft. Further provided herein are uses of the filter, e.g., in any place or with any material that is desired to be filtered, to filter a material by contacting the material to be filtered with the filter provided herein, wherein at least one substance is removed from the material to be filtered.

In some other embodiments, also provided is an air-filtering mask containing the filter as described herein.

What is described in this specification can be modified in a variety of ways while remaining within the scope of the claims. Therefore all embodiments disclosed herein should be considered as illustrative embodiments of the present disclosure and should not be considered to represent the entire scope of the disclosure.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A filter, comprising:
one or more nanofibers;
one or more nanoparticles, wherein the nanoparticles are at least partially embedded in the one or more nanofibers; and
one or more pockets, wherein the pockets at least partially surround the one or more nanoparticles.

2. The filter of claim 1, wherein at least one of the nanoparticles and at least one of the pockets are at least partially exposed to the outside of the nanofiber.

3. The filter of claim 1, wherein the one or more nanofibers include a material selected from the group consisting of silica, carbon, and a combination thereof.

4. The filter of claim 1, wherein the one or more nanofibers include silica.

5. The filter of claim 1, wherein the one or more nanofibers include carbon.

6. The filter of claim 1, wherein the one or more nanoparticles are selected from the group consisting of silver (Ag), copper (Cu), iron (Fe), platinum (Pt), nickel (Ni), titanium (Ti) and combinations thereof.

7. The filter of claim 1, wherein the one or more nanoparticles comprise silver (Ag).

8. An air-filtering mask comprising the filter of claim 1.

9. A device selected from the group consisting of an air-conditioner, an air-purifier, an air-cleaner, a water-filtering system, and a water-purification system, comprising a filter, wherein the filter comprises one or more nanofibers, one or more nanoparticles at least partially embedded in the nanofibers, and one or more pockets which at least partially surround the nanoparticles.

10. The device of claim 9, wherein said device is utilized at a place selected from the group consisting of a residential area, a commercial area, a non-commercial area, a school, a hospital, a vehicle, a car, an airplane, a train, a subway, and a watercraft.

11. A method of manufacturing a filter comprising:
heating one or more nanoparticles coated with a surfactant in an organic solvent;
mixing a molten nanofiber source material together with the one or more nanoparticles in the organic solvent;
evaporating the organic solvent from the mixture of molten nanofiber source material and the heated nanoparticles;
making a nanoparticle-embedded nanofiber from the mixture of molten nanofiber source material and heated nanoparticles;
removing the surfactant from the nanofiber; and
forming the filter from the one or more nanofibers.

12. The method of 11, wherein at least one of the nanoparticles and at least one of the pockets are exposed to the outside of the nanofiber.

13. The method of claim 11, wherein removing the surfactant comprises: heating the nanofiber with the at least partially embedded nanoparticles, wherein the nanoparticles are coated with the surfactant.

14. The method of claim 13, wherein heating the nanofiber comprises: providing heat having a temperature ranging from about 350° C. to about 550° C. to the nanofiber.

15. The method of claim 11, wherein the nanofiber source material is selected from the group consisting of silica, carbon, and a combination thereof.

16. The method of claim 11, wherein the nanoparticle is selected from the group consisting of silver (Ag), copper (Cu), iron (Fe), platinum (Pt), nickel (Ni), titanium (Ti) and combinations thereof.

17. The method of claim 11, wherein the surfactant is selected from the group consisting of dodecane thiol, trioctylphosphine, oleic acid, cetyltrimethyl ammoniumbromide (CTAB), hexadecyltrimethyl ammoniumbormide (HTMAB2), P123, Triton X-100, and combinations thereof.

18. The method of claim 11, wherein the organic solvent is selected from the group consisting of toluene, acetone, benzene, cyclohexane, t-butyl alcohol, any known organic solvent, and combinations thereof.

19. A method of regenerating the filter of claim 1, comprising:
heating the filter containing a filtrand; and
contacting the heated filter with H₂ gas.

20. A method of regenerating the filter of claim 1, comprising:
exposing the filter containing a filtrand to radiation selected from the group consisting of visible light, infrared light, ultraviolet light, X-ray, microwave, and combinations thereof.

21. A method of filtering, comprising:
contacting the filter of claim 1 with a material to be filtered.

22. The method of claim 21, wherein the material is selected from the group consisting of gas, liquid, gel and the combinations thereof.

23. The method of claim 22, wherein the gas is selected from the group consisting of air, oxygen, carbon dioxide, nitrogen, hydrogen, and combinations thereof.

24. The method of claim 22, wherein the liquid is selected from the group consisting of water, a saline solution, a medical solution, a biological solution, a pharmaceutical solution, and combinations thereof.

25. The method of claim 21, wherein the method of filtering is performed at a place selected from the group consisting of a residential area, a commercial area, a non-commercial area, a school, a hospital, a vehicle, a car, an air-plane, a train, a subway, and a watercraft.

26. The method of claim 21, wherein the filter is positioned in an air-filtering mask.
